(19) United States
(12) Patent Application Publication
(10) Pub. No.: US 2011/0137865 A1
(43) Pub. Date: Jun. 9, 2011

(54) Method for managing storage service

(75) Inventors: Hun Shin, Daegu (KR); Juncheol Hwang, Anyang-si (KR); Kwang Young Park, Seoul (KR)

(73) Assignee: KOREA I.O. TECH, Seoul (KR)

(21) Appl. No.: 12/659,386

(22) Filed: Mar. 8, 2010

(30) Foreign Application Priority Data
Dec. 3, 2009 (KR) 10-2009-0119024

(51) Int. Cl. G06F 12/16; G06F 17/30

(52) U.S. Cl. 707/648; 707/E17.005

(57) ABSTRACT

A method for managing a storage service wherein checking and updating a result of a backup task are facilitated by analyzing a backup end log. In accordance with the method, the result of the backup task is determined by comparing the parameter of the backup end log with that of the backup script and is updated based on user input to obtain reliable statistics of the backup task.

This application claims the benefit of Korean Patent Application No. 10-2009-0119024 filed on Dec. 3, 2009, which is hereby incorporated for reference.

### BACKGROUND OF THE INVENTION

1. Field of the Invention

The present invention relates to a method for managing a storage service, and more particularly to a method for managing a storage service wherein checking and updating a result of a backup task are facilitated by analyzing a backup end log.

2. Description of the Related Art

A storage system includes a client and a storage server wherein a backup of a data stored in the client is made in the storage server. The storage system makes the backup of the data in the storage server so that the data may be restored when the data is deleted or lost by a mistake of a user, an error of a software, a failure of a hardware, a computer virus, a theft, a cyber attack, a disaster and the like.

The storage system employs an application so-called a storage manager to carry out a backup task. Tivoli Storage Manager (TSM) by IBM and Netbackup by Symantec are some of well-known storage managers.

The storage manager is executed in the storage server. The storage manager provides storage services described below to the client connected to the storage server in order to backup the data and manage archives.

First, the storage manager guarantees a data integrity. The storage manager may protect the data stored in the storage server in order to prevent manipulation.

Second, the storage manager provides a data storage for the data. That is, the storage manager may store the data and programs of the client in storage of the storage server such as a tape cartridge, an optical disk, an opto-magnetic disk and hard disk arrays.

Third, the storage manager provides a security for the data. That is, the storage manager may restore the data and the programs from the storage server when the data is lost.

A conventional storage system employing the TSM by IBM is described hereinafter.

FIG. 1 is a block diagram illustrating the conventional storage system.

Referring to FIG. 1, the conventional storage system comprises a storage server 100 and a client 200. The storage server 100 may be a TSM server and the client 200 may be a TSM client.

The storage server 100 stores a data transmitted from the client 200. The storage server 100 stores the data based on a backup script received from the storage server 100.

The storage server 100 stores the data received from the client 200 in storage media such as a disk in a storage hierarchy and a tape volume.

The client 200 transmits the backup script to the storage server 100 and requests the storage server 100 to store the data. The client 200 may transmit the backup script to the storage server 100 directly. Alternately, the client 200 may transmit the backup script to the storage server 100 via a scheduler.

The storage server 100 carries out a backup task based on the backup script. The backup script includes one or more information on the backup script. The one or more information may be stored in a command format.

The one or more information included in the backup script are as follows.

First, an information on backup tools may be included.

When a storage service is provided using the TSM, the information may include the types of the backup tools such as DSMC, backint, domdsmc, tdpsqlc, pcbax, Exchange, brbackup, brarchive, db2, sysback, mkdirback and dtobackup.

When a storage service is provided using the TSM, the information may include the types of the backup tools such as dsmc, backint, domdsmc (for domino), tdpsqlc (for mssql), pcbax (for CBMR), tdpexcc (for exchange server), brbackup (for SAP DB), brarchive (for SAP Archive Log), db2, sysback (for AIX OS Backup), mkdirback (for AIX FileSystem Backup) and dtobackup (for SQL-Backtrack).

Second, an information on backup modes may be included.

When a storage service is provided using the TSM, the information may vary according to the types of the backup tool. For instance, when DSMC is used, the backup mode may be an incremental backup mode wherein the backup task is carried out for a modified portion of the data since a last backup task, a selective backup mode wherein the backup task is carried out for selected files or folders, an archive backup mode and an image backup mode.

Third, the information on a backup type may be included.

The backup type may be a domino backup type, a database export backup type, a file backup type, a database online backup type, a database offline backup type, an operating system backup type, a trans backup type, NAS backup type and an archive log backup type.

Fourth, the information on a backup interval may be included.

The backup interval may be a day, a week or a month.

In accordance with the conventional storage system, the backup script is created by a user. That is, the user should create the backup script, which is required for the backup task, including information on an operating system, the types of the backup tools, the backup mode, the backup type, and the backup interval. Therefore, the user is required to have an expert knowledge on the backup script in order to take advantage of the storage server.

Moreover, the user may not receive an accurate result of the backup task since the user checks the result determined by the client based on a log generated by the storage server.

The log is generated whenever the backup script is executed in the storage server regardless of a completion of the backup task carried out in the storage server. For instance, the log is generated whenever the backup script executed even when the backup task is not carried out due to an insufficient disk space in the storage server or the typographical error in the backup script.

Therefore, the user must check the result based on the backup script. However, the result may not be accurate because an administrative policy or criteria of each user on which the backup script is based may vary.

Moreover, a discrepancy between the determinations of the result by the user and the client may cause problems. That is, even when the result determined by the client is a failure and the result determined by the user is a success, the result cannot be modified.

### SUMMARY OF THE INVENTION

It is an object of the present invention to provide a method for managing a storage service wherein checking and updating a result of a backup task are facilitated by analyzing a backup end log.

In order to achieve above-described object of the present invention, there is provided a method for managing a storage service provided by a storage management server managing a backup script executed by a storage server, the method comprising steps of: (a) receiving a backup end log of a backup task carried out using the backup script; (b) analyzing the backup end log to determine a result of the backup task; and (c) storing the result of the backup task.

Preferably, the script is generated automatically using a backup script generating logic.

Preferably, the step (b) comprises determining the result by comparing a parameter used for generating the backup script with a parameter included in the backup end log.

Preferably, each of the parameters comprises at least one of informations on a backup target, a backup tool, a backup mode and a backup interval.

Preferably, each of the parameters comprises management informations on an object designated as a backup target, an object subjected to the backup task, an object subjected to the backup task determined as success, and an object subjected to the backup task determined as failure.

Preferably, each of the management informations comprises at least one of identification information of the object and a number of the object.

Preferably, the result is at least one of success, failure and warning.

The method in accordance with the present invention may further comprise (d) updating the result based on a user input.

The method in accordance with the present invention may further comprise (e) storing a result statistics information of the storage service prior to carrying out the step (a); and (f) updating the result statistics information based on the result after carrying out the step (c).

Preferably, the result statistics information comprises a backup execution information and a backup result information on the storage service, wherein the backup execution information comprises a number of the backup task carried out in the storage service, and the backup result information comprises a number of the backup task determined as success and a number of the backup task determined as failure in the storage service, wherein the result for the backup task is at least one of success, failure and warning, and wherein the step (f) comprises, (f-1) increasing the number of the backup task by 1; and (f-2) increasing the number of the backup task determined as success by 1 when the backup task is determined as success, and increasing the number of the backup task determined as failure by 1 when the backup task is determined as warning or failure.

The method in accordance with the present invention may further comprise updating the result statistics information based on a user input.

### BRIEF DESCRIPTION OF THE DRAWINGS

FIG. 1 is a block diagram illustrating the conventional storage system.

FIG. 2 is a block diagram illustrating a storage system in accordance with the present invention.

FIG. 3 is a flow diagram illustrating a method for managing a storage service in accordance with the present invention.

FIG. 4 is a flow diagram illustrating another preferred embodiment of a method for managing a storage service in accordance with the present invention.

FIG. 5 depicts a user interface for displaying a result statistics information of a method for managing a storage service in accordance with the present invention.

FIG. 6 depicts a user interface for updating a result statistics information of a method for managing a storage service in accordance with the present invention.

FIG. 7 depicts updating a result statistics information based on a user input.

### DETAILED DESCRIPTION OF THE INVENTION

A method for generating a backup script in accordance with the present invention will be described in detail with reference to accompanied drawings.

FIG. 2 is a block diagram illustrating a storage system in accordance with the present invention.

Referring to FIG. 2, the storage system in accordance with the present invention comprises a storage server 100, a client 200 and a storage management server 300.

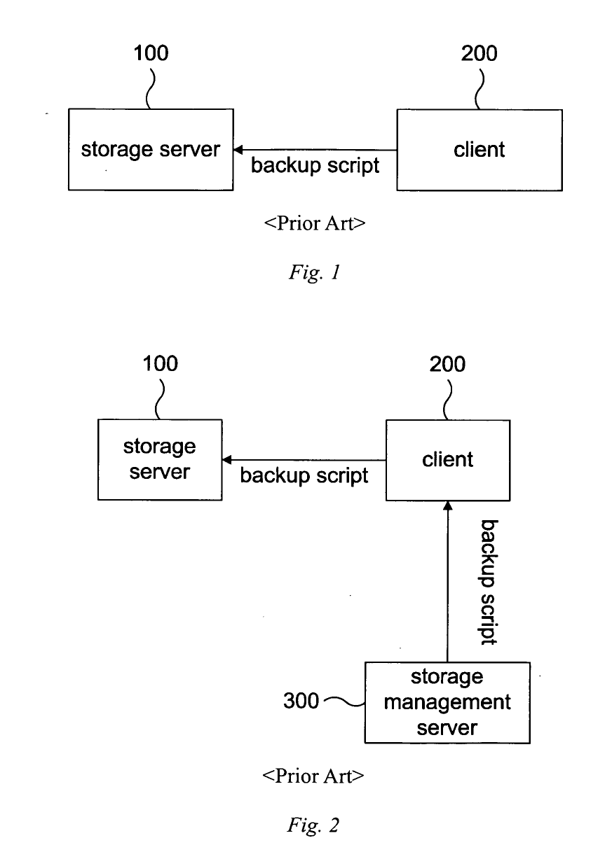

Since configurations of the storage server 100 and the client 200 in accordance with the present invention are identical to those described with reference FIG. 1, the detailed descriptions thereof are omitted.

The storage management server 300 automatically generates a backup script and transmits the same to the client 200. The storage management server 300 also receives a backup end log to determine whether a backup task of a storage service failed.

Specifically, the storage management server 300 stores a backup script generating logic. When the storage management server 300 receives a request for the backup script from the client 200 or a user console (not shown) connected to the client 200, the storage management server 300 generates the backup script based on the backup script generating logic. Preferably, the backup script generating logic stores parameters for the backup task and generates the backup script based on the parameters.

While it is preferable that the method in accordance with the present invention is carried out in the storage management server 300, the method may be carried out in the storage server 100, the client 200 or the user console when the storage management server 300 is not employed.

The method for managing the storage service carried out in the storage management server 300 in accordance with the present invention will be described in detail hereinafter.

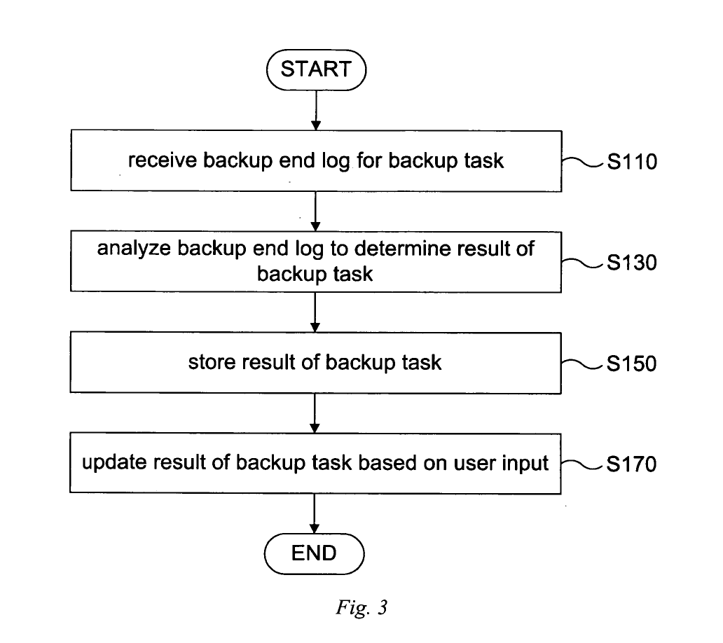

FIG. 3 is a flow diagram illustrating the method in accordance with the present invention.

Referring to FIG. 3, a backup end log for a backup task is received from the storage server (denoted as 100 in FIG. 2) or the client (denoted as 200 in FIG. 2) (S110).

Specifically, the storage server carries out a plurality of the backup tasks based on the backup script generated the storage management server through the client.

The storage server generates the backup end log for completed backup task and transmits the backup end log to the storage server or the client via FTP or some other file transfer scheme.

Preferably, the backup script generated by the storage management server 300 contains a parameter of the backup task. The storage server carries out the backup task according to the parameter of the backup task. The backup end log may include a parameter for determining a result of the backup task.

Each of the parameters may include informations on a backup target, a backup tool, a backup mode, a backup type and backup interval.

In addition, each of the parameters may contain detailed informations on the backup task such as management informations on objects designated as the backup target, objects which was subjected to the backup task, objects which was subjected to a successful backup task, and objects which was subjected to an unsuccessful backup task.

Preferably, each of the management informations includes at least one of identification information of corresponding objects and the number of the corresponding objects.

Thereafter, the backup end log is analyzed to determine the result of the backup task (S130).

Specifically, the storage management server compares the parameter included in the backup script with that of the backup end log to determine the result of the backup task. In addition, the storage management server may determine the result of the backup task using an analysis algorithm.

The result may be determined as one of success, warning and failure or one of success and failure.

The storage management server may determine the result by comparing the information included in the parameter of the backup end log such as the informations on a backup target, a backup tool, a backup mode, a backup type and backup interval designated by the backup script with those of the backup script.

In addition, the storage management server may determine the result by comparing the management informations included in the parameter of the backup script with those of the backup end log.

For instance, the result may be determined by comparing the number of the objects designated as the backup target with that of the objects which was subjected to the backup task, by comparing the number of the objects designated as the backup target with that of the objects which was subjected to the successful backup task or by checking the number of the objects which was subjected to the unsuccessful backup task.

Specifically, when the number of the objects designated as the backup target is different from that of the objects which was subjected to the backup task, when the number of the objects designated as the backup target is different from that of the objects which was subjected to the successful backup task or when the number of the objects which was subjected to the unsuccessful backup task is not zero, the result of the backup task may be determined as failure.

Moreover, when the number of the objects designated as the backup target is same as that of the objects which was subjected to the backup task, when the number of the objects designated as the backup target is same as that of the objects which was subjected to the successful backup task or when the number of the objects which was subjected to the unsuccessful backup task is zero, the result of the backup task may be determined as success.

In addition, when a warning situation occurs during the backup task, the storage server may generate the backup end log including a warning message. When the backup end log containing the warning message is received, the storage server determined the result of the backup task as warning.

Thereafter, the result of the backup task is stored (S150).

The storage management server classifies and stores the result of the backup task. That is, the storage management server classifies and stores the backup end log indicated the result.

The storage management server stores the result by determining at least one of success, failure and warning, and may include a “success” folder, a “failure” folder or a “warning” folder.

When the result of the backup task is determined on success or failure, the storage management server stores the backup end log indicated the result determined as success in the “success” folder, and the backup end log indicated the result determined as failure in the “failure” folder. The backup end log indicated the result determined as warning may be stored in the “warning” folder.

Thereafter, the result of the backup task is updated based on a user input (S170).

Since the storage management server determines the result of the backup task by analyzing only the parameters of the backup script and the backup end log, the result may have errors therein.

For instance, when the backup task for the objects of insignificance fails, the storage management server may still determine the backup task as failure.

For another instance, when a portion of the objects designated as the backup target is deleted by another process during the backup task, the storage management server may still determine the backup task as failure. However, the user may not deem the result of the backup task for the objects of insignificance and the objects deleted by another process as failure. In other words, the user may determine the result of the backup task as success or warning.

Therefore, it is preferable that the user updates the result of the backup task by checking the backup end log via the client or the user console connected to the client.

When the user is to change the result of the backup task after checking the backup end log stored in the “success” folder, the “failure” folder or the “warning” folder, the user may generate the user input via the client or the user console connected to the client. The storage management server may update the backup end log based on the user input received from the client or the user console connected to the client.

Another preferred embodiment of the method in accordance with the present invention is described hereinafter.

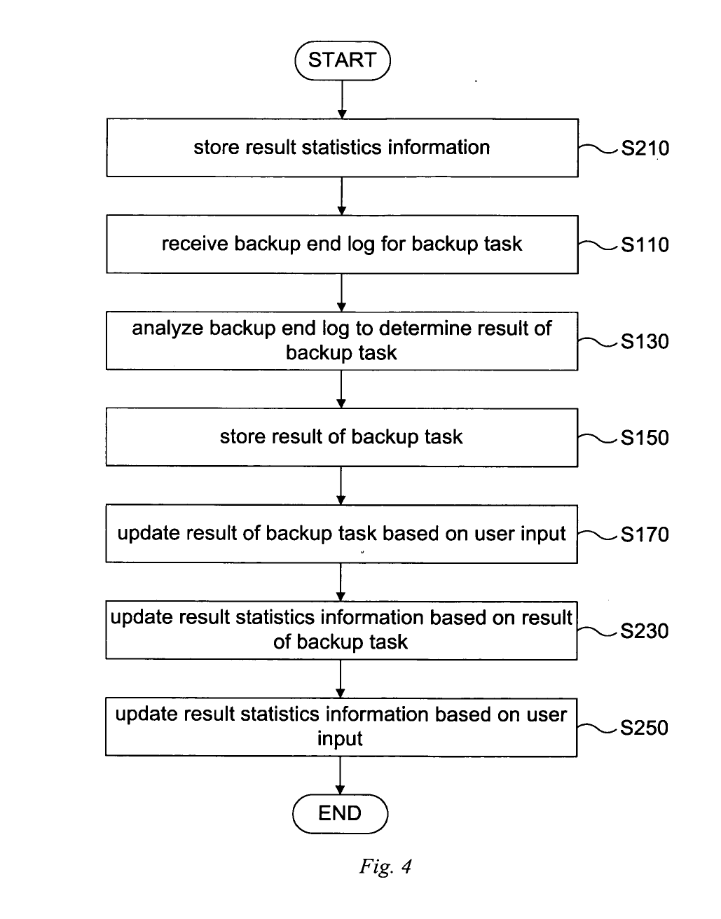

FIG. 4 is a flow diagram illustrating another preferred embodiment of the method in accordance with the present invention.

Referring to FIG. 4, the storage management server stores a result statistics information for the storage service (S210).

The result statistics information may include a backup execution information and a backup result information.

Specifically, the backup execution information contains the number of the backup task carried out by the storage service. The backup result information contains the number of the backup task determined as success and the number of the backup task determined as failure.

The result statistics information may be provided daily, weekly, monthly or yearly.

Thereafter, steps S110 through S170 are carried out. Since the steps S110 through S170 are same as the method described with reference to FIG. 1, a detailed description is omitted.

Referring back to FIG. 4, the storage management server updates the result statistics information based on the backup end log updated in the S170 (S230).

The storage management server updates the number of the backup task determined as success and the number of the backup task determined as failure after increasing the number of the backup task included in the backup execution information by 1.

That is, when the backup task is determined as success, the number of the backup task determined as success is increased by 1, and when the backup task is determined as failure, the number of the backup task determined as failure is increased by 1.

Thereafter, the result statistics information is updated based on the user input (S250).

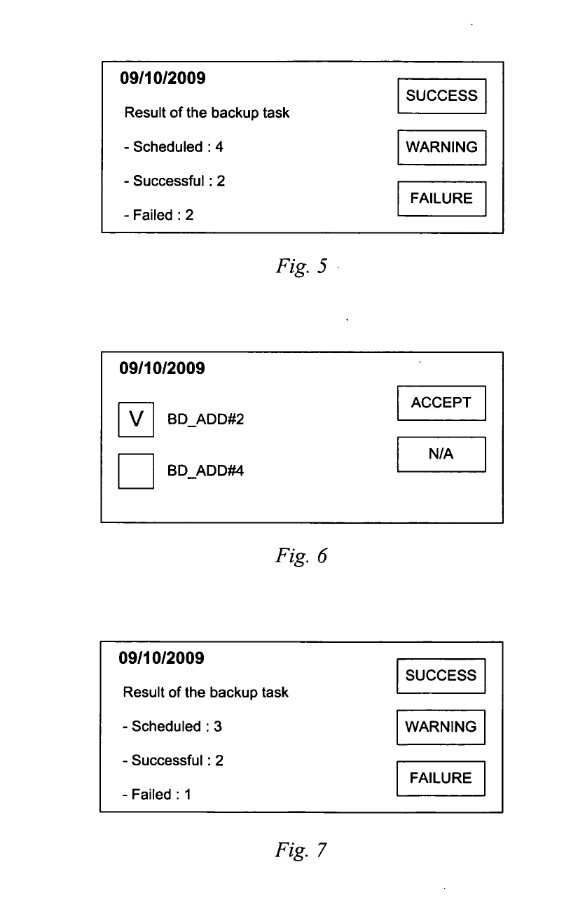

The step S250 is described in detail with reference to FIGS. 5 through 7.

FIGS. 5 through 7 exemplify a user interface for displaying the result statistics information in the method in accordance with the present invention.

FIG. 5 depicts the result statistics information for the backup task of the storage service carried out on Oct. 9, 2009 wherein the number of the backup task is 4, the number of the backup task determined as success is 2 and the number of the backup task determined as failure is 2.

Referring to FIG. 5, the user interface displays the number of the backup task as “scheduled: 4”, the number of the backup task determined as success as “successful: 2” and the number of the backup task determined as failure as “failed: 2”

Buttons denoted as “SUCCESSFUL”, “WARNING” and “FAILED” may be pressed to check informations on the backup task.

When the clicks the “SUCCESSFUL”, “WARNING” and “FAILED” buttons, the information on the backup task determined as success, warning and failure are displayed, respectively.

When the “FAILED” button is pressed, the information is displayed as shown in FIG. 6.

Referring to FIG. 6, the user interface displays the backup tasks BD_ADD#2 and BD_ADD#4 which are determined as failure.

When the backup tasks BD_ADD#2 is to be excluded from the result statistics information, the user may check a check box and press “N/A” button. The storage management server may then update the number of the backup task to 3, the number of the backup task determined as success to 2 and the number of the backup task determined as failure to 1 as shown in FIG. 7.

The method for managing the storage service in accordance with the present invention has following advantages.

Errors in the backup script created by the user may be prevented because the backup script is generated by the backup script generating logic.

The result of the backup task may be easily checked because the result is determined by comparing the parameter of the backup end log with that of the backup script.

A reliability of the result of the backup task is improved because the result may be updated based on a user intervention.

Statistics informations such as a success rate of the backup task may be accurately obtained because the result statistics information is stored and updated based on the user intervention.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A method for managing a storage service provided by a storage management server managing a backup script executed by a storage server, the method comprising steps of
(a) receiving a backup end log of a backup task carried out using the backup script;
(b) analyzing the backup end log to determine a result of the backup task; and
(c) storing the result of the backup task.

2. The method in accordance with claim 1, wherein the script is generated automatically using a backup script generating logic.

3. The method in accordance with claim 1, wherein the step (b) comprises determining the result by comparing a parameter used for generating the backup script with a parameter included in the backup end log.

4. The method in accordance with claim 3, wherein each of the parameters comprises at least one of informations on a backup target, a backup tool, a backup mode and a backup interval.

5. The method in accordance with claim 3, wherein each of the parameters comprises management informations on an object designated as a backup target, an object subjected to the backup task, an object subjected to the backup task determined as success, and an object subjected to the backup task determined as failure.

6. The method in accordance with claim 5, wherein each of the management informations comprises includes at least one of identification information of the object and a number of the object.

7. The method in accordance with claim 1, wherein the result is at least one of success, failure and warning.

8. The method in accordance with claim 1, further comprising (d) updating the result based on a user input.

9. The method in accordance with claim 1, further comprising:
(e) storing a result statistics information of the storage service prior to carrying out the step (a); and
(f) updating the result statistics information based on the result after carrying out the step (c).

10. The method in accordance with claim 9, wherein the result statistics information comprises a backup execution information and a backup result information on the storage service,
wherein the backup execution information comprises a number of the backup task carried out in the storage service, and the backup result information comprises a number of the backup task determined as success and a number of the backup task determined as failure in the storage service,
wherein the result for the backup task is at least one of success, failure and warning, and
wherein the step (f) comprises,
(f-1) increasing the number of the backup task by 1; and
(f-2) increasing the number of the backup task determined as success by 1 when the backup task is determined as success, and increasing the number of the backup task determined as failure by 1 when the backup task is determined as warning or failure.

11. The method in accordance with claim 10, further comprising updating the result statistics information based on a user input.
